(19) United States
(12) Patent Application Publication
(10) Pub. No.: US 2004/0243420 A1
(43) Pub. Date: Dec. 2, 2004

(54) Pre-paid entertainment/informational system

(76) Inventor: Alma Alicia Francis, St. Thomas, VI (US)

Correspondence Address: ALMA ALICIA FRANCIS, P.O. Box 307877, St. Thomas, VI, 00803, US

(21) Appl. No.: 10/445,650

(22) Filed: May 27, 2003

(51) Int. Cl. G06F 17/60

(52) U.S. Cl. 705/1

(57) ABSTRACT

A computerized method and system for providing pre-recorded data and/or a live connection via the use of a pre-paid phone card, pre-paid account and/or calling card. A user requests access to the computerized system by entering a pin code number. Once accessed is authorized, user will be navigated thru system to a database of pre-recorded stories, fantasies, descriptions and/or information so they can listen to one or more of them. If user opts to have a conversation with a live connection i.e, a personified person, about a story, fantasy, description and/or information instead of the listening to the pre-recorded data, they will then be connected via the computer system to an extension to proceed with said conversation. This system and method can be utilized with the help of a telephone, cell phone, television, internet, CD, DVD, and/or by any communications means present or otherwise.

This present invention is a computerized method and system for providing pre-recorded data and/or a live connection via the use of a pre-paid phone card, pre-paid account and/or calling card.

The pre-recorded data shall comprise of stories, fantasies, descriptions and/or information as told to user in the voice of an automated person, a personified person and/or character. The live connection will comprise of a conversation between a user and a personified person who will convey to and/or converse with user about a story, fantasy, description and/or information.

The design of the pre-paid phone card, pre-paid account and/or calling card shall have on side one the monetary value, a photograph, picture, drawing, and/or description of the pre-recorded data and/or live connection associated with that card. On side two, an access number, information on how to use the card, a personal identification number (pin code), associated websites and company logo.

A pre-paid account shall comprise of any account that has been set-up and/or utilized to grant access to the pre-recorded data and/or live connection.

This computerized system shall be accessed once the authorization of the personal identification number received thru the use of a pre-paid phone card, pre-paid account and/or calling card is verified. Once access is granted, user will then be navigated thru the system to the pre-recorded data and/or live connection associated with that card.

If for some reason the user cannot gain access to the computerized system, they will then be connected to a customer service representative. Only if the reason for non-access is determined to be time value expiration, then user will be given the option to obtain additional time. Billing information will be requested from user and processed via the computer system by a series of voice commands, touch commands and/or by any means present or otherwise. User will also have the option to obtain time value when time on pre-paid card, pre-paid account and or calling has almost expired. User will be informed prior to the end of the pre-recorded data and/or live connection of time limitations and user will have the option to buy additional time.

### BACKGROUND OF INVENTION

Prepaid phone cards, pre-paid accounts and/or calling cards are generally used to connect to long distance service providers. However, all of these pre-paid systems are not used to connect to a service which provides pre-recorded data of a story, fantasy, description and/or information. Also, these pre-paid systems are not used to grant access to a live connection, i.e. a personified person, who will convey to and/or converse with user about a story, fantasy, description and/or information. Thus, this invention utilizes the use of these various pre-paid systems to connect to a computerized system that will allow user to listen to pre-recorded data and/or speak to a live connection.

### SUMMARY OF INVENTION

This invention provides for a computerized method and system of using a pre-paid phone card, pre-paid account and/or calling card to listen to pre-recorded data and/or to speak to a live connection. The pre-recorded data shall comprise of a story, fantasy, description and/or information. The live connection shall consist of a conversation where a story, fantasy, description and/or information is convey to and/or conversed about with user.

The pre-paid phone cards, pre-paid accounts and/or calling cards may have on side one, the monetary value, a photograph, picture, drawing, and/or description of the pre-recorded data and/or live connection associated with that card. On side two, an access number, information on how to use the card, a personal identification number (pin code), associated websites and company logo. For example, on the front of a card, has how much the card costs, a picture of a character named “Mr. Bentwood”, this card will give you a brief description of “Mr. Bentwood” and if the pin code will grant access to a pre-recording or a live connection with “Mr. Bentwood” Also on the front of some or all of the cards, there will be a push a button to hear a brief pre-recorded message from “Mr. Bentwood.” On the back-side of the card will have a access number, instructions using the card, a pin code, associated websites and company logo.

Once the user has purchased the card, they will then use a communications method and/or device such as a telephone, to access the computerized system. For example, after a user has the card they uses thir home phone to call the access number then enter the pin code. The computerized system will then let the user to know that specific pin code gives them access to listen to a 20 minute story told to them by “Mr. Bentwood.” The computerized system will then tell the user that the character “Mr. Bentwood” has four different stories stored in the data base and they must say or push number 1 to hear story 1, say or push number 2 to hear story 2, ect.

Another example of card use, is that after the pin code is entered and user is authorized, the computerized system will let user know that that pin code gives them access to a live connection to speak with “Mr. Bentwood” for 20 minutes about a specific fantasy and/or a fantasy of their choice. The computerized system will then connect them to an extension to converse with “Mr. Bentwood”

One of the major advantages of using this invention is the ability for users to set a budget. This invention will limit the amount of money a user spends depending on the monetary value of the card. The user knows how much the service cost and can budget accordingly.

This invention is so useful that it can accompany user to any location, and could be used at any time at any place. For example a user is on a business tip and they are lonely in their hotel room. They are upset at the fact that they were supposed to go hunting this weekend. The go down stairs to the lobby of the hotel and tells the receptionist that he wishes to open a an account that will give them access to the computerized entertainment database for an hour. The user pays $20 into their new account and the receptionist activates their account and give them a pin code. The user now goes back up stairs and presses the appropriate number, and is told that he has an one hour of access time to the entertainment computerized system. After going thru the procedures and choosing a story of going “deer hunting”, user can lie in his bed with the lights out and relaxed and listen for an entire hour to his story.

This invention is also great to be used with the television as well. A specific channel(s) is designated for its use. A user purchases a pre-paid card, goes home and calls an access number that will grant them access to a specific channel(s). Once user is granted access, they then watch the character associated with that card and listen to the fantasy they had requested thru the computerized system.

Some of the pre-paid cards, pre-paid accounts and or calling cards can be geared specifically to adults. Those cards will have on their font an advisory of “ADULT CONTENT” and that they cannot be sold to minors. For example a minor comes in a grocery store and says he wants a card that has on a photo of “Boom Boom Belinda.” The owner of the store sees that on the card that there is an advisory of adult content that that card shall not be sold to minors. The store owner proceeds to inform the minor that they must show ID to purchase that card. If appropriate Identification is not supplied, card shall not be sold. The owner could then suggest to the minor an alternative card, “Mars Exploration” a story of going on a space adventure to mars.

As a added bonus of purchasing a pre-paid phone card, pre-paid account and/or pre-paid calling card, user may receive in packaging and/or thru place of purchase, a poster of a photograph, picture or drawing that is similar or the same as the one on the card.

If during access to the pre-recorded data and/or live connection, if time value expires, user may have the option to replenish their pre-paid phone card, pre-paid account and/or calling card by supplying the necessary information via the use of voice commands, touch commands and/or by any means present or otherwise, to retrieve specified monetary amount. For example a user utilized the pre-paid account and has pre-paid for 30 minutes. During the time of the live connection, the user only has only 1 minute left on their account, the computerized system then tells the user that they only have one minute left and asks if they wish to continue beyond the 1 minute time period. The user will then be instructed to say yes or press 1 or say no or press 2. If the user says yes or presses 1, their “live connection will be temporarily put on hold and the consumer will then be asked to say or punch in the needed information to bill their credit card, telephone bill, checking account or any means of payment available thru the computerized system. Once approval of payment has been confirmed by the system, user will then be reconnect to their live connection. If consumer says no or presses 2, the computerized system will then thank them and allow the session to continue until time has expired.

This invention is a great source of entertainment or information for any sex or age group. It is an excellent tool for children, even on an educational basis. For example your child has an up coming algebra exam. You have to work late for the next two weeks and can't help them study. Also you might have no recollection on algebra. You could go and set-up a pre-paid account specifically for algebra. This account is valid for one week. You give your child the access number and pin code number then tell them they have one week. When the child accesses the database, they will be told that there are 7 different pre-recordings and that each is 30 minutes. In that week period, that child could call in and listen to all 7 categorized pre-recordings or just the pre-recording they need the extra help with. Another variation of the algebra pre-paid account is that a pre-paid account was set up for a week to speak to a live connect, i.e. a math teacher, that will converse with that child about algebra and help them better understand that subject better.

There are many variations to this invention. The main goal is that entertainment and/or information can be conveniently accessible to the consumer on a pre-paid basis.

### BRIEF DESCRIPTION OF THE DRAWINGS

This invention is described thru the following figures

FIG. 1: Is a flowchart of how to use this invention.

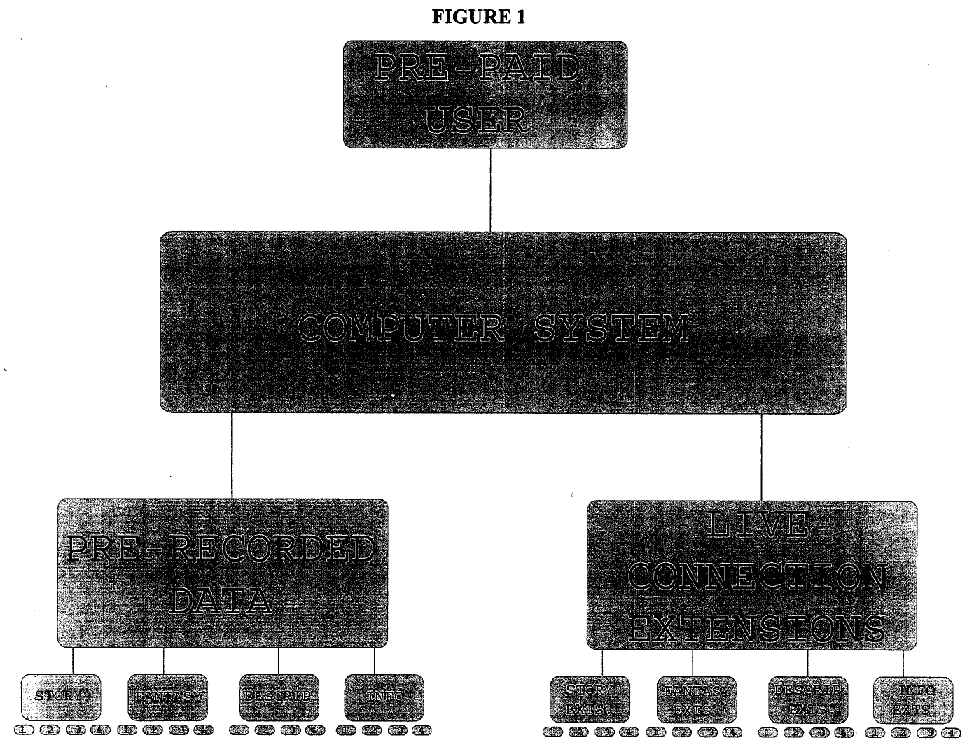

FIG. 2: Is a flow chart of how to use this invention via the Internet.

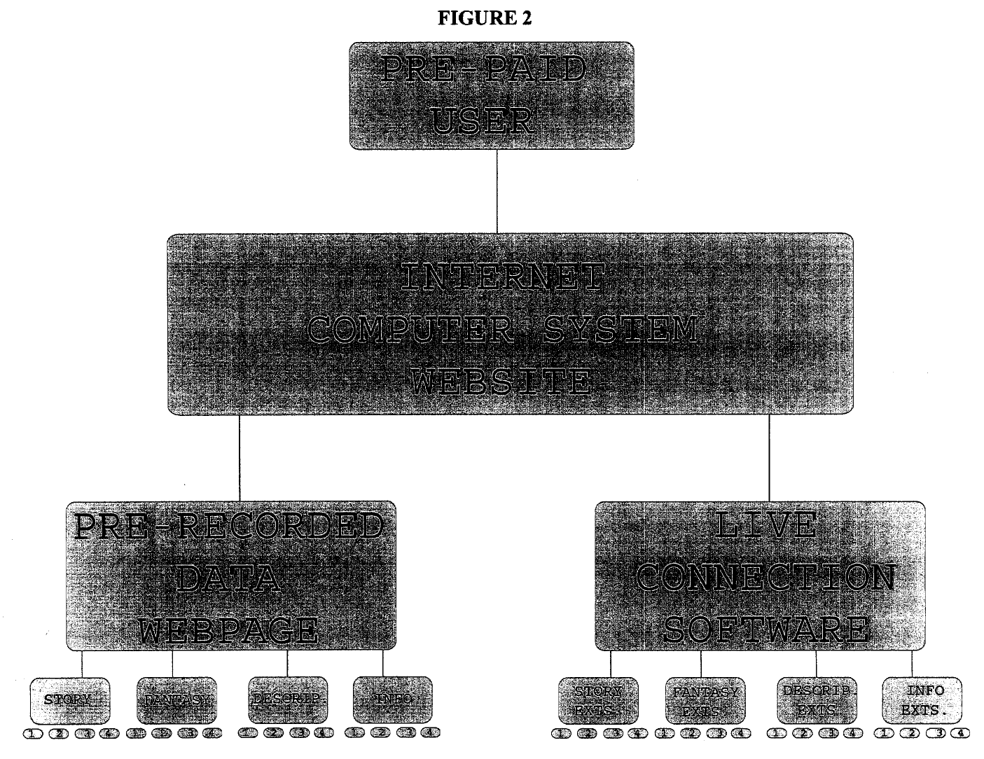

FIG. 3: Is a flowchart of how to use this invention via the television.

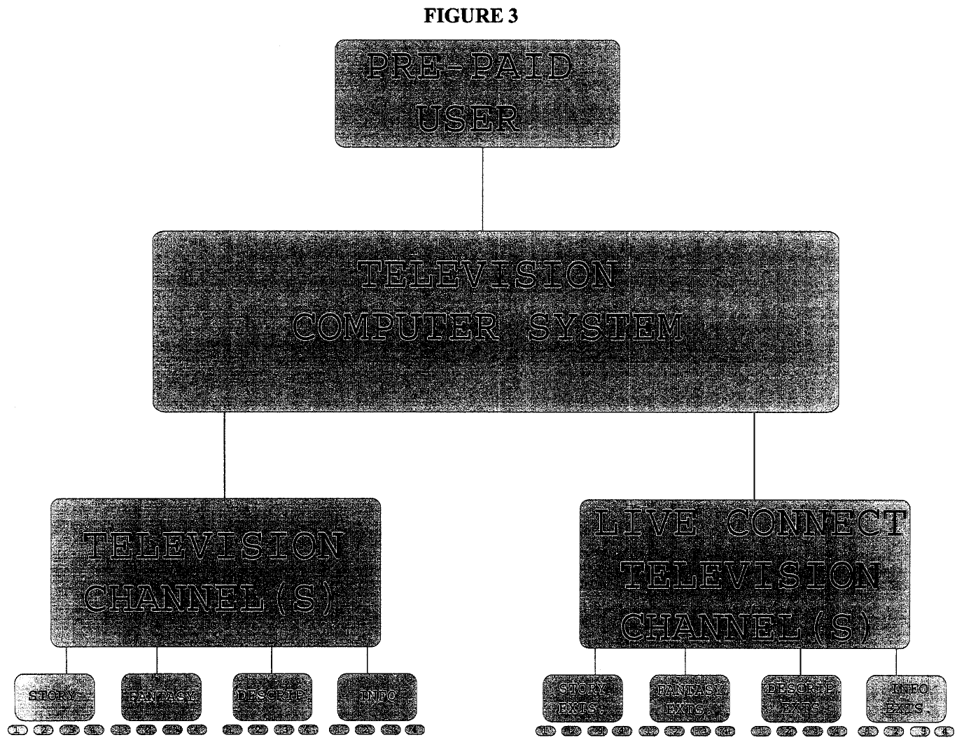

### DETAILED DESCRIPTION OF PREFERRED EMBODIMENTS

This present invention is a computerized method and system for providing pre-recorded data and/or a live connection via the use of a pre-paid phone card, pre-paid account and/or calling card for entertainment/Informational purposes. This invention could be used by any person of any age. It can be used by parents to help their children get access to information, it could be used by adults to go on a mental journey to faraway places.

This present invention is for the use of pre-paid phone cards, pre-paid accounts, and/or calling cards to be used to access a computerized system. Pre-paid cards could be in a variety of monetary denominations of $10, $20, $30, ect, that will represent the time value allotted to user.

These pre-paid phone cards, pre-paid accounts, and/or calling cards could be sold in any type of store and/or establishment. They can also be sold in establishments associated with the type of card that was purchased, i.e. Adult stores, hunting shops, children stores, educational stores.

This invention is a great form of entertainment and a budgetary constraint. User can rest assured that they won't have to worry about over spending, calls being billed to telephone and/or credit card.

This present invention is a safe way, in that each pin code will only be able to access the pre-recorded data base and/or live connect associated with that card. That way a child with a pre-paid card for a bedtime story cannot use the same pin code to access an adult story.

This present invention is a great marketing tool for companies as well. They could purchase thousands of pre-paid cards and give them away to random users, pre-paid cards that will advertise their business, ect.

This present invitation could be accessed with a CD and/or DVD. The user calls in activates the account with the pin code. User will then be given a access code to enter when they launch the CD and/or DVD to get access to the pre-recorded data, photos, ect. of a specific character.

A television is also a perfect tool for this invention. It involves a user going to a specific channel(s), then calling in to the computerized system, uses the pin code, gets authorization, then access shall be granted to that specific channel(s) then user will be connected to speak to a live connect whom he will also be able to also see on that channel as they participate or act out a story, fantasy, description and/or information. If user is granted access the pre-recorded database, they can then watch and listen to the character associated with that card tell a story, fantasy, description and/or information.

The internet is also a great tool for this invention. It involves user going to an associated website, user will then be prompted to enter a pin code, then launch special software so they can connect to a live connect via the use of their computer headphones, microphone and speakers to have desired conversation. If user opts for pre-recorded date, they will be granted access to the webpage with the embedded pre-recorded data along with associated photos, pictures, and drawings.

It is understood that this invention is not limited to the embodiments referred to above but will include any and all embodiments and/or variations of this invention.

I claim:

1. A computerized method and system for providing pre-recorded data and/or a live connection via the use of a pre-paid phone card, pre-paid account and/or calling card.

2. A method of claim 1, wherein pre-recorded data shall comprise of stories, fantasies, descriptions and/or information.

3. A method of claim 1, wherein pre-recorded data shall be in the voice of an automated person, a personified person and/or character.

4. A method of claim 1, wherein a live connection is: A personified person who will converse with and/or convey to user, stories, fantasies, descriptions and/or information.

5. A method of claim 1, wherein a live connection shall be a person, mimic a person and/or character.

6. A method of claim 1, wherein pre-paid phone cards, pre-paid accounts and/or calling cards may have on side one, the monetary value, a photograph, picture, drawing, and/or description of the pre-recorded data and/or live connection associated with that card.

7. A method of claim 1, wherein pre-paid phone cards, pre-paid accounts and/or calling cards may have on side two, an access number, information on how to use the card, a personal identification number (pin code), associated websites and company logo.

8. A method of claim 1, wherein packaging of phone cards, pre-paid accounts and/or calling card may have a corresponding poster and/or cards of the photograph, picture and/or drawing that is similar or the same as the one associated with that card.

9. A method of claim 1, wherein the utilization of a telephone, cell phone, the Internet, television, DVD, CD and/or any means of communication present or otherwise, shall be used along with the pre-paid phone card, pre-paid account and/or calling card to access the computerized system.

10. A method of claim 9, wherein the utilization of the Internet shall comprise of user going to an associated website, user will then be prompted to enter a pin code, then they will be granted access to the pre-recorded data along with associated photos, pictures, and drawings.

11. A method of claim 9, wherein the utilization of the Internet shall comprise of user going to an associated website, user will then be prompted to enter a pin code, then launch special software so they can connect to a live connect via the use of their computer headphones, microphone and speakers to have desired conversation.

12. A method of claim 9, wherein the utilization of the television shall comprise of user going to a specific channel(s), then calling in to the computerized system, uses the pin code number, gets authorization, then access shall be granted to that specific channel(s) and user can then watch the character associated with that card and listen to the story; fantasy, description and/or information.

13. A method of claim 9, wherein the utilization of the television shall comprise of user going to a specific channel(s), then calling in to the computerized system, uses the pin code number, gets authorization, then access shall be granted to that specific channel(s) then user will be connected to speak to a live connect whom he will also be able to see on that channel as they participate or act out a story, fantasy, description and/or information.

14. A method wherein access to the computerized system shall be granted thru the authorization of a personal identification number (pin code) located on and/or obtained thru the use of a pre-paid phone card, pre-paid account and/or calling card.

15. A method of claim 14, wherein the computerized system shall determine at least one or all of the following, once the pre-paid signal has been received by the system: access authorization, expiration, time availability, product identity and the category associated with the pre-paid phone card, pre-paid account and/or calling card.

16. A method of claim 14, wherein if the computerized system cannot determine at least one or all of the following, system shall grant user the option to obtain time value via a pre-paid account and/or be connected to a customer service representative.

17. Once authorization is established, user will be navigated thru computer system to a database of pre-recorded stories, fantasies, descriptions and/or information so they can listen to one or more of them.

18. Once authorization is established, if user has opted to have a conversation with a live connection i.e, a personified person, about a story, fantasy, description and/or information, instead of listening to pre-recorded data, they will then be connected to an extension to proceed with said conversation.

19. Time value allotted to listen to the pre-recorded data and/or to speak to a live connection, shall be determined by the monetary amount paid for the pre-paid phone card, pre-paid account and/or calling card.

20. During access to the pre-recorded data and/or live connection, if time value expires, user may have the option to replenish their pre-paid phone card, pre-paid account and/or calling card by supplying the necessary information via the use of voice commands, touch commands and/or by any means present or otherwise, to retrieve specified monetary amount.
